(19) United States
(12) Patent Application Publication
(10) Pub. No.: US 2010/0021225 A1
(43) Pub. Date: Jan. 28, 2010

(54) DISTRIBUTION DEVICE FOR COSMETIC ACCESSORIES AND ASSOCIATED METHOD OF PREPARATION

(75) Inventors: Vincent DE LAFORCADE, Rambouillet (FR); Laure Thiebaut, Clichy (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/496,670

(22) Filed: Jul. 2, 2009

Related U.S. Application Data
(60) Provisional application No. 61/086,970, filed on Aug. 7, 2008.

(30) Foreign Application Priority Data
Jul. 2, 2008 (FR) 08 54507

(51) Int. Cl. B43K 27/00; B43K 29/00

(52) U.S. Cl. 401/29; 401/193

(57) ABSTRACT

The device comprises an accessory support including detachable cosmetic accessories. It includes a distributor for cosmetic accessories, defining a guide path for the accessory support. The accessory support includes at least one chain of cosmetic accessories disposed end to end, being connected to one another by breakable linkages. The breakage of one of the breakable linkages in order to detach a cosmetic accessory from the support results in a reduction in the length of the chain of accessories, viewed along the guide path.

The present invention concerns a cosmetic accessories distribution device for, of the type comprising:
at least one accessory support comprising a plurality of cosmetic accessories, each cosmetic accessory being detachable with respect to the other cosmetic accessories of the accessory support;
a cosmetic accessory distributor defining a guide path for the accessory support, the accessory support being displaceable along its length in the guide path between a position retracted into the distributor and a plurality of deployed positions for use of an accessory.

The accessories are in particular cosmetic product applicators having an active portion intended to come into contact with the skin or the keratin fibres of a user, or cosmetic treatment tools such as nail files or massage rollers.

By “cosmetic product” there is meant in particular a product as defined in the directive 93/35/EEC of the Council of the 14 Jun. 1993.

Such a device, when it comprises a cosmetic product applicator, is intended for example to deposit a cosmetic product onto keratin fibres, such as hair or eyelashes, including hair extensions or eyelash extensions.

The product is advantageously a cosmetic make-up product and or cosmetic care product, such as for example mascara.

By “mascara” there is meant a composition intended to be applied to the eyelashes. It may be an eyelash make-up composition, a composition for cosmetic treatment of the eyelashes, a make-up base for the eyelashes, or a composition termed “top-coat” applied onto a first layer, itself already applied to the eyelashes.

In order to apply conventional mascara formulae, it is known to use a packaging comprising an applicator and a reservoir of cosmetic product.

However, some mascara formulae, owing to their chemical or physical nature, cannot be removed from the applicator after the application of the mascara to the eyelashes.

Thus, some cosmetic formulae undergo a chemical and/or physical modification when they are extracted from the reservoir, for example when they contain a product reacting with oxygen. In other cases, the formula dries rapidly on the applicator and it is difficult to remove the residue of dried formula sticking to the applicator.

The applicator may then become unusable and no longer permit effective separation of the eyelashes.

Moreover, when a soiled applicator is reinserted into the reservoir of cosmetic product, it may contaminate the cosmetic product contained in the reservoir. This contamination may, especially in formulae devoid of a preservative, result in drying of the formula, or in a change in colour, viscosity or appearance.

In all the cases mentioned previously, it is necessary to provide single-use applicators which can be replaced after each application of product.

In addition, such a replacement after each use may prove necessary when the same reservoir of cosmetic product is used for applying cosmetic product to several users, for example in a beauty salon.

For the case where the applicator must be replaced after each use, distribution devices are known which comprise a plurality of single-use applicators.

Such a distribution device is described for example in the document U.S. Pat. No. 3,690,452. The device comprises a distribution case and a continuous support for applicators that can be extracted longitudinally from the case. The continuous support comprises a longitudinal framework onto which are detachably fixed transversely a plurality of single-use applicators.

Before each use, the user opens the case, then displaces the framework towards the outside and detaches an applicator in order to apply the product.

Such a device does not give complete satisfaction. It is very bulky, since each applicator comprises a body long enough to allow it to be grasped by the user's fingers and the product to be applied. Owing to its size, the device is expensive to produce.

It is an aim of the invention to obtain a cosmetic accessory distribution device including a plurality of single-use accessories, and which is compact and inexpensive.

To this end, the subject of the invention is a device of the aforesaid type, characterized in that the accessory support comprises at least one chain of cosmetic accessories disposed end to end, being connected to one another by breakable linkages, the breakage of one of the breakable linkages in order to detach a cosmetic accessory from the support resulting in a reduction in the length of the chain of accessories, viewed along the guide path.

The device comprises one or more of the following features, taken singly or in all technically possible combinations:
the plurality of cosmetic accessories and the breakable linkages of the chain of accessories are integral;
each cosmetic accessory comprises:
   a longitudinal base connected to a longitudinal base of at least one adjacent accessory by a breakable linkage; and
   at least one transverse portion which protrudes transversely with respect to the longitudinal base;
the base and the transverse portion form an applicator end-piece for cosmetic product;
the transverse portion comprises a connecting arm which protrudes transversely with respect to the longitudinal base, and an applicator end-piece for cosmetic product, disposed at a free end of the arm;
each breakable linkage comprises a longitudinal member having a first point of connection with a first accessory of the chain of accessories and a second point of connection with a second accessory of the chain of accessories;
at least the first accessory has a user protection edge which protrudes longitudinally with respect to the first point of connection towards the second accessory, the protection edge extending longitudinally in register with the longitudinal member;
the guide path defined by the distributor is linear, the accessory support extending linearly at least when it is disposed in the guide path of the distributor;
the guide path defined by the distributor is curved, the accessory support assuming a curved configuration at least when it is disposed in the guide path of the distributor;
the accessory support comprises a device for displacement of the chain of accessories in the distributor, mounted to be secured and separate from the chain of accessories, the displacement member being capable of being grasped by a user of the device via the distributor in order to displace the chain of accessories in the distributor along the guide path;
the distributor comprises:
   a hollow body for receiving the accessory support; and
   a support head protruding from the hollow body, the guide path extending through the hollow body and through the support head, each accessory being covered by the hollow body to prevent the use of the accessory when it is disposed in the hollow body, the space located above an accessory being freed in order to permit the use of the accessory, when it is disposed in the support head;
the guide path of the distributor is defined by a groove or a channel having a cross-section substantially matched to the cross-section of at least one cosmetic accessory of the accessory support; and
each cosmetic accessory is selected from a cosmetic product applicator or a cosmetic treatment tool.

The invention also has as its subject a method of preparation of a device as defined above for the use of a cosmetic accessory, characterized in that it comprises the following steps:
displacement of the accessory support in the guide path as far as a deployed position;
breakage of a breakable linkage between a first cosmetic accessory and a second cosmetic accessory, the breakage of the breakable linkage and the detachment of the first cosmetic accessory resulting in a reduction in the length of the chain of accessories, viewed along the guide path.

The invention will be better understood from the following description, provided solely by way of example and with reference to the appended drawings, in which:

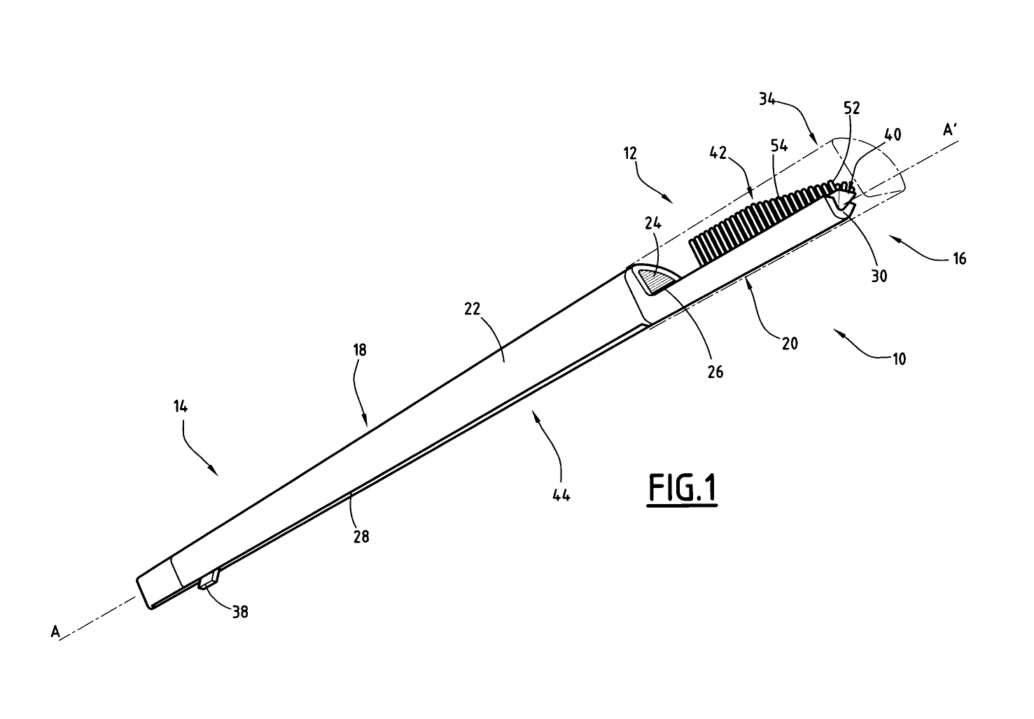

FIG. 1 is a perspective view from below of a first distribution device according to the invention, a continuous accessory support being disposed in the distributor;

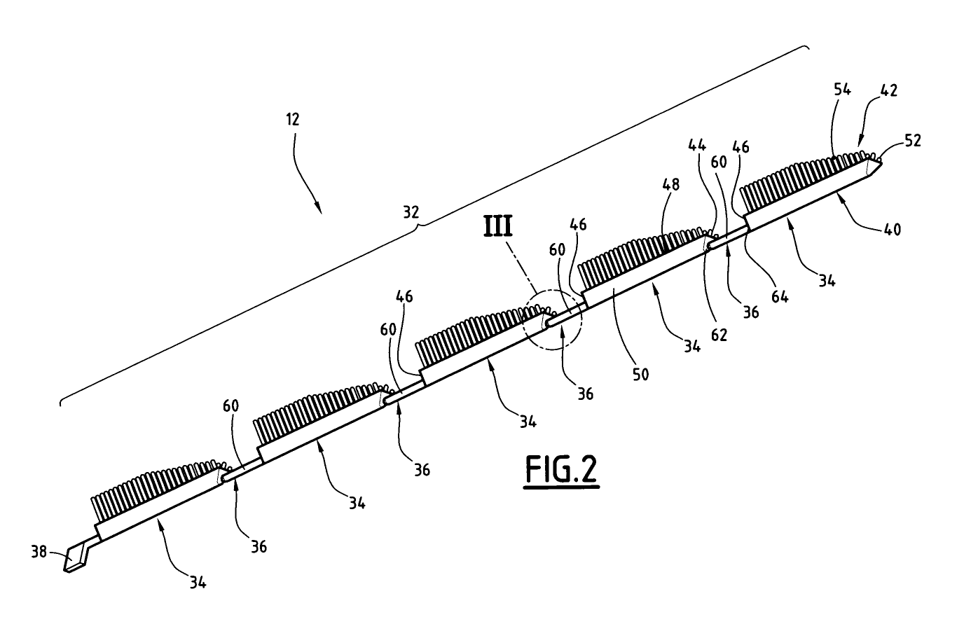

FIG. 2 is a view similar to FIG. 1 of the continuous accessory support;

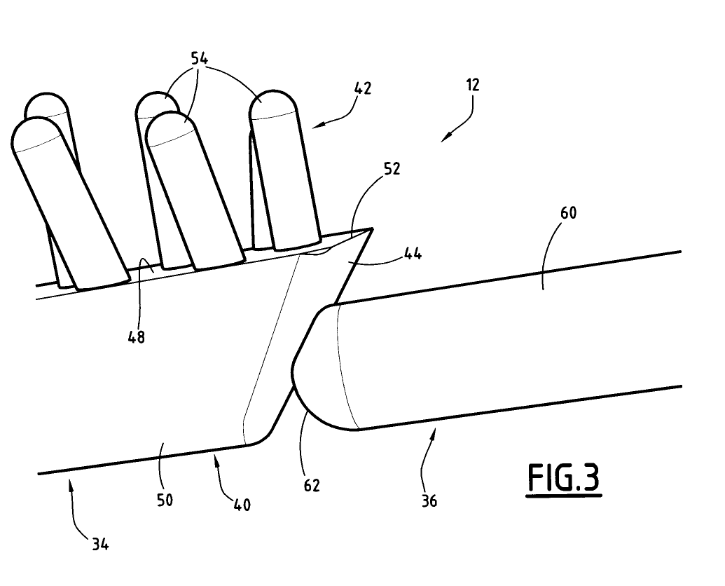

FIG. 3 is a view of a detail marked III in FIG. 2;

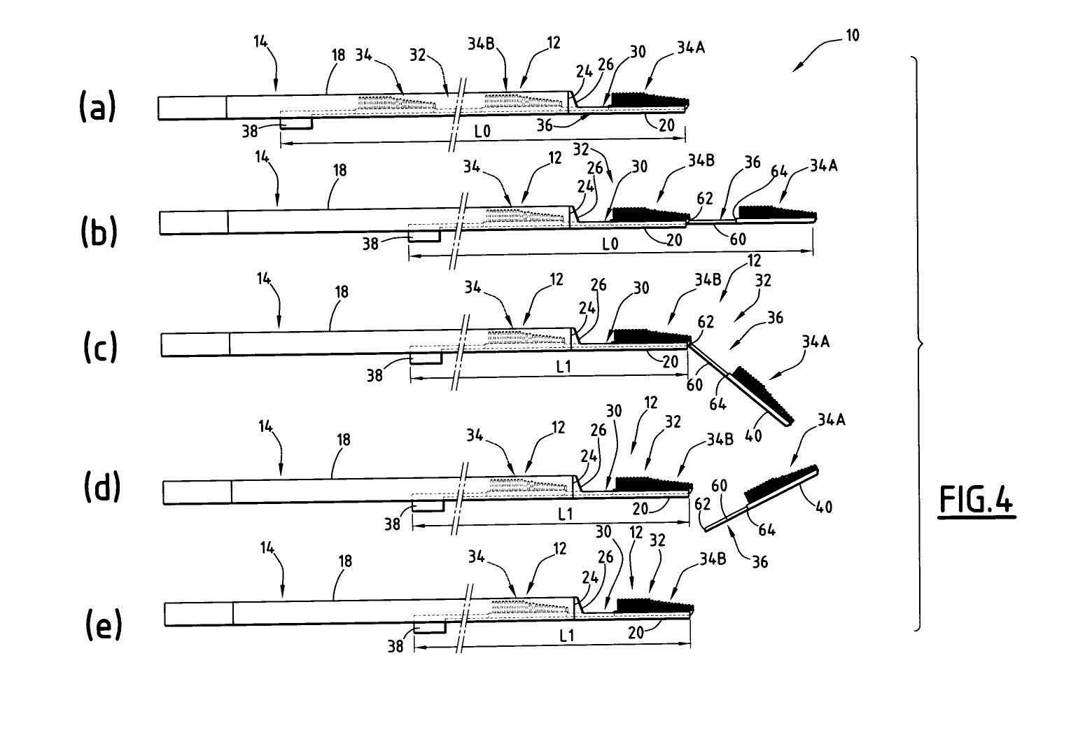

FIG. 4 is a partial side view of the end of the device of FIG. 1, during different steps of the method of use of the device;

FIG. 5 is a view similar to FIG. 4, illustrating the gradual reduction in length of the continuous accessory support of the device of FIG. 1;

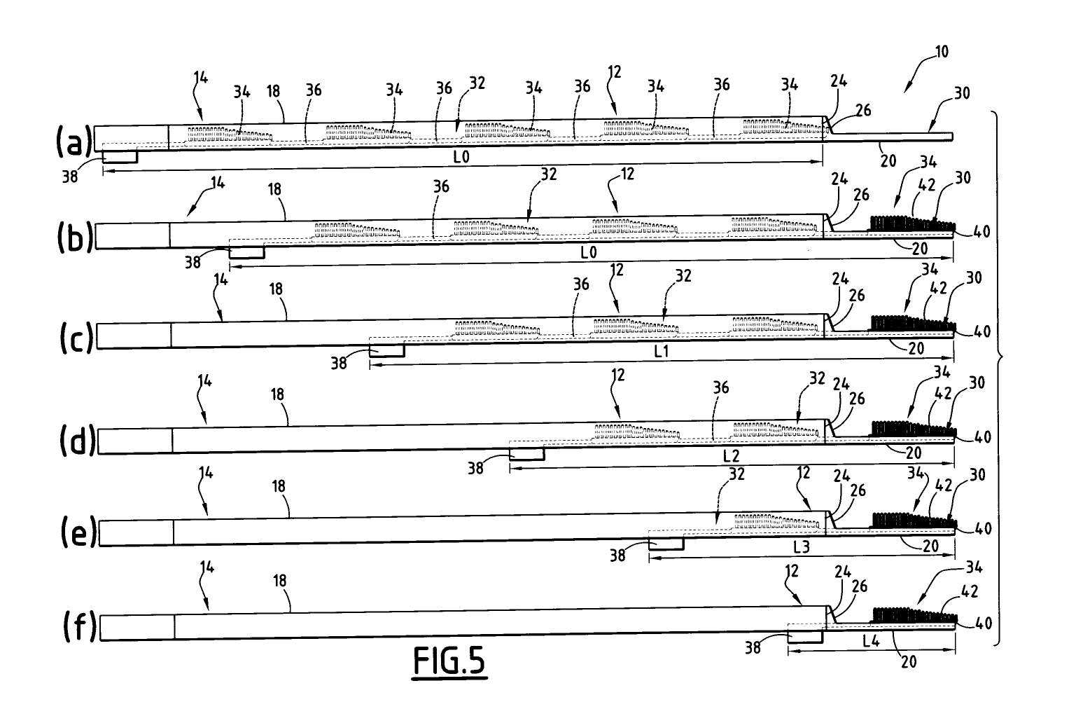

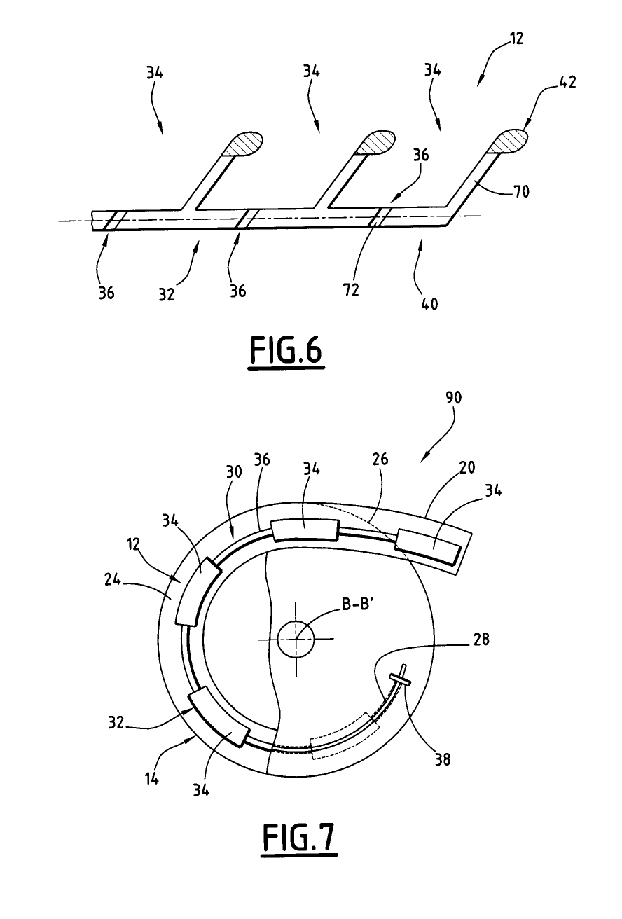

FIG. 6 is a partial side view of the accessory support of a second application device according to the invention;

FIG. 7 is a top view, partially cut away, of a third distribution device according to the invention;

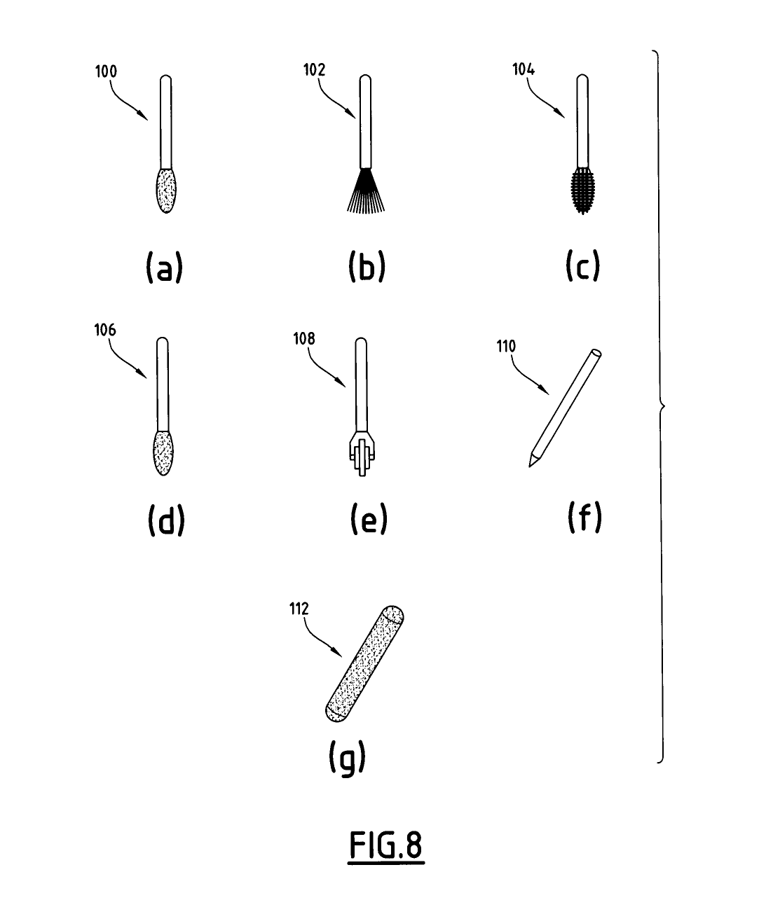

FIG. 8 is a view illustrating different types of cosmetic accessories for devices according to the invention;

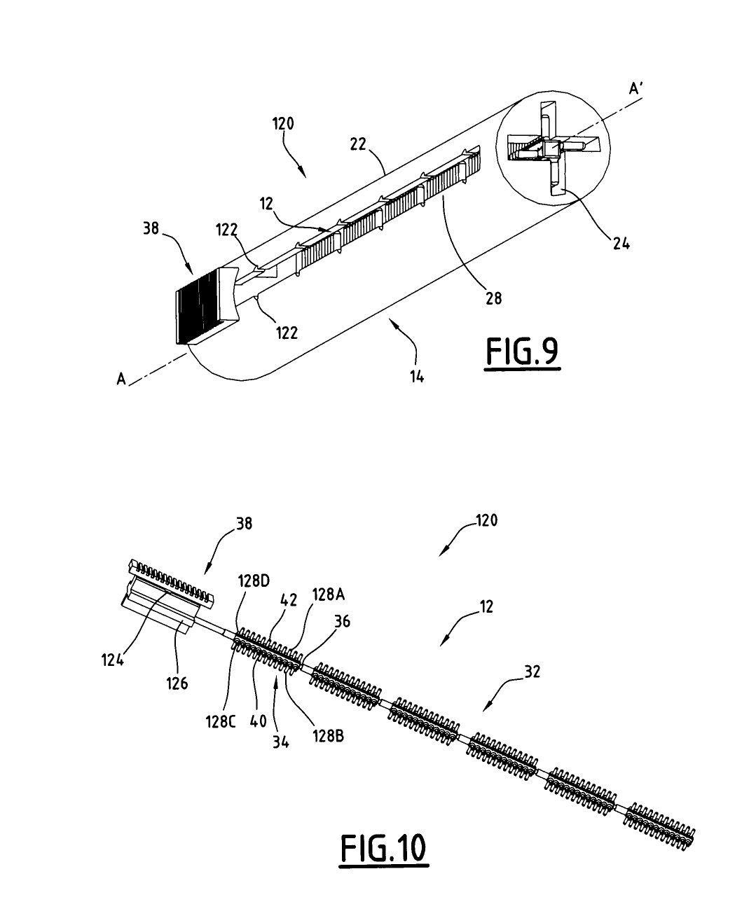

FIG. 9 is a view similar to FIG. 1 of a fourth distribution device according to the invention;

FIG. 10 is a view similar to FIG. 2 of the continuous accessory support of the fourth device according to the invention;

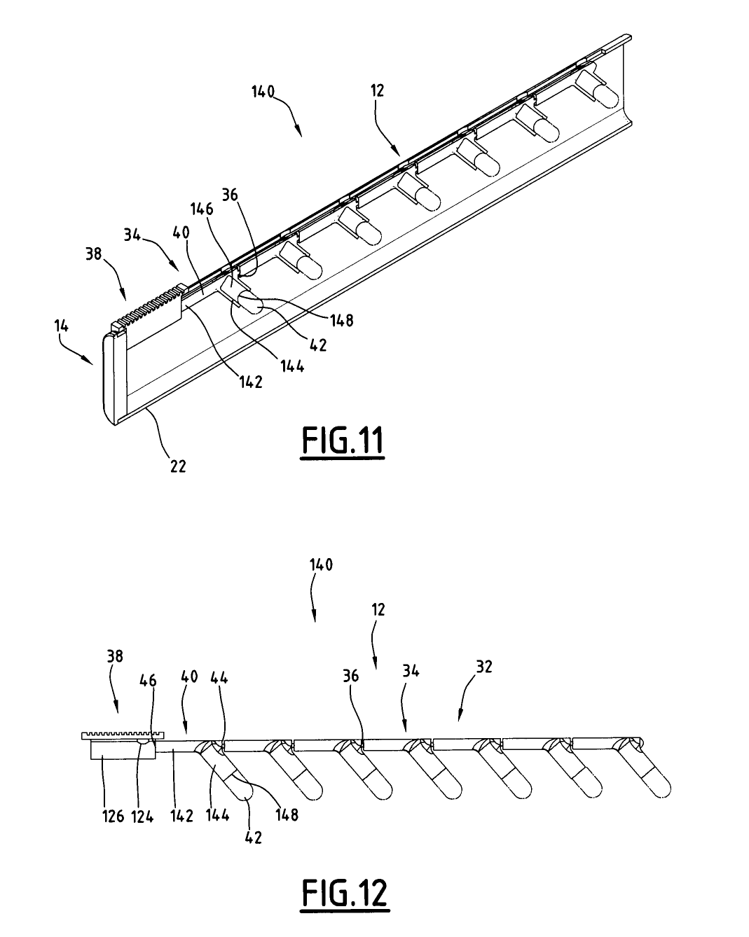

FIG. 11 is a perspective view partially in section along a vertical median plane of a fifth distribution device according to the invention;

FIG. 12 is a side view of the continuous accessory support of the fifth device according to the invention;

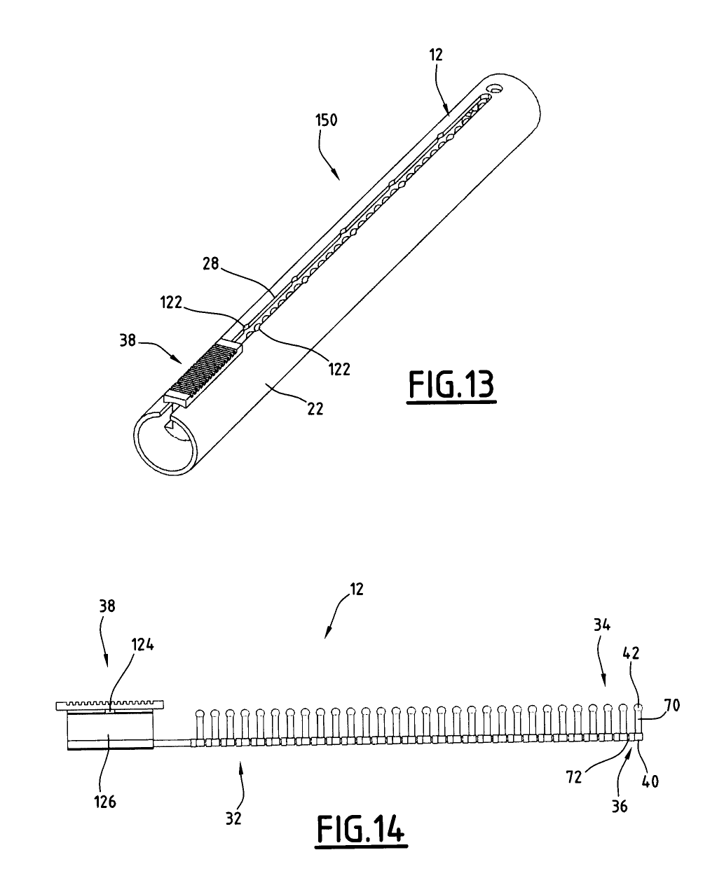

FIG. 13 is a perspective top view of a sixth distribution device according to the invention;

FIG. 14 is a side view of the continuous accessory support of the sixth device according to the invention;

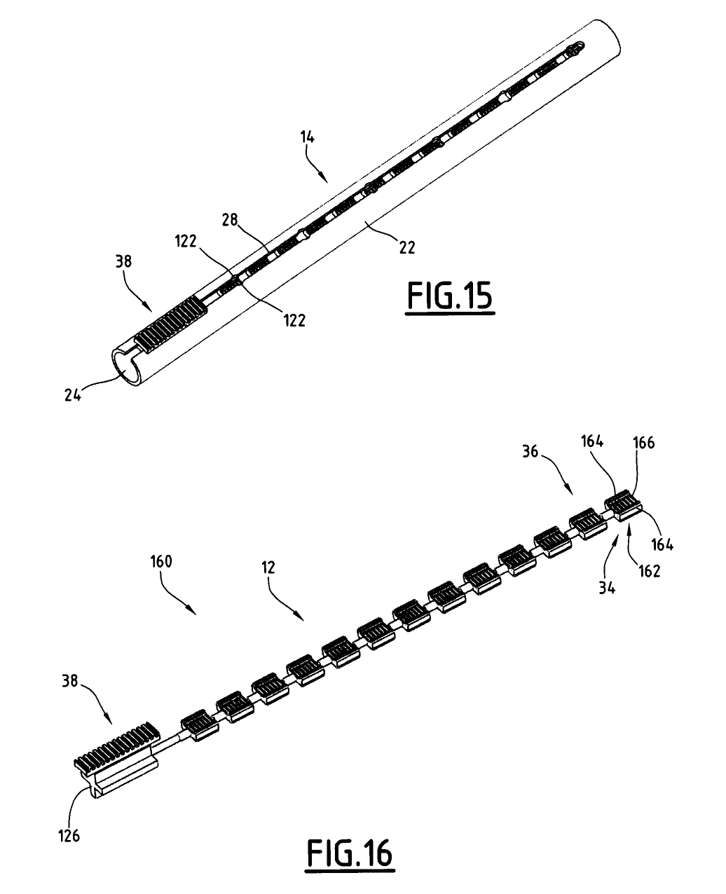

FIG. 15 is a view similar to FIG. 13 of a seventh distribution device according to the invention;

FIG. 16 is a perspective top view of the continuous accessory support of the device of FIG. 15 before the loading of the cosmetic product;

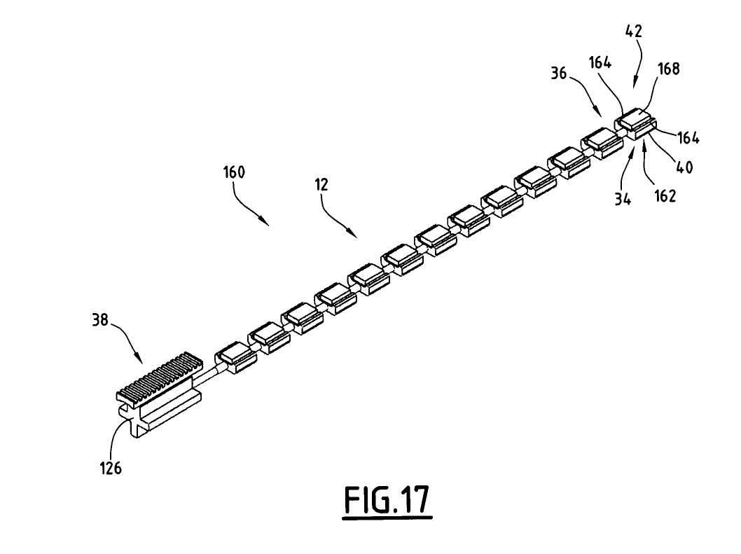

FIG. 17 is a view similar to FIG. 16 of the accessory support of an eighth device according to the invention after the loading of the cosmetic product.

Throughout the following, the orientations are provided relative to the drawings. The terms “front” and “rear” are to be understood as relative with respect to the position of a user during the use of the device, the term “front” being understood as closer to the point of use of the accessory on the user, while the term “rear” is to be understood as further away from that point.

FIGS. 1 to 5 illustrate a first distribution device 10 for cosmetic accessories according to the invention. In this example, the device 10 is intended for the application of a cosmetic product to the keratin fibres of a user, by means of a single-use cosmetic accessory formed by a cosmetic product applicator.

The device 10 comprises a continuous support 12 for detachable cosmetic accessories, visible in particular in FIG. 2, and an accessory distributor 14, capable of distributing and carrying the different cosmetic accessories of the continuous support 12 in succession when the support 12 is introduced into the distributor 14.

In this example, the device 10 additionally comprises, as illustrated schematically in FIG. 1, a cosmetic product reservoir 16 forming a closure cap of the distributor 14.

The distributor 14 extends along a longitudinal axis A-A′. It comprises a grip member intended to be grasped by the user, the grip member being formed in this example by a hollow tubular body 18 with axis A-A′. The device 10 further comprises an accessory support head 20 which protrudes longitudinally at a front end of the body 18.

The body 18 comprises a substantially solid tubular peripheral wall 22 with axis A-A′. The wall 22 defines internally an orifice 24 for circulation of the continuous accessory support 12.

The orifice 24 opens out axially at a front end of the body 18, opposite the support head 20, and opens out transversely downwards through a guide slot 28.

The guide slot 28 extends longitudinally along a generatrix of the wall 22.

The peripheral wall 22, along the slot 18, has raised portions or nibs (not shown) for indexing the displacement of the continuous support 12, which protrude into the slot 28, to form releasable stops for immobilizing the support 12.

The wall 22 covers the accessories of the continuous support 12 which are disposed in the orifice 24, such that the accessories of the support 12 cannot be used when they are disposed in the orifice 24.

The support head 20 extends longitudinally towards the front in prolongation of the body 18 and of the slot 28.

In a first embodiment, the support head 20 is integral with the hollow tubular body 18. As a variant, the head 20 is added on to the hollow tubular body 18 by being fixed by any suitable fixing means such as by force fit, snap-fitting, screwing, adhesive securing or crimping.

The head 20 is open at the top. Thus, when an accessory of the support 12 is disposed in the head 20, the space disposed above the accessory is freed and the accessory can be used.

The peripheral wall 22 located on each side of the slot 28, and the support head 20 define a profiled guide path 30 in the form of a groove for the continuous accessory support 12. The guide path 30 extends linearly parallel to the axis A-A′ and has a substantially V-shaped cross-section.

In the example shown in FIG. 1, the cosmetic product reservoir 16 is fixed releasably on the grip member 18 to cover the head 20. The reservoir 16 and the tubular member 18 are then equipped with releasable and reversible fixing means such as a screw thread disposed for example on the reservoir 16 and engaged on a screw pitch integral with the member 18.

As a variant, the reservoir 16 is independent of the distributor 14 and may be common to a plurality of distributors 14.

As illustrated in FIG. 2, the continuous accessory support 12 comprises a chain 32 of cosmetic accessories 34 connected to one another by breakable linkages 36. The support 12 further comprises a button 38 for controlling the displacement of the chain 32 in the distributor 14, along the guide path 30.

By “chain” there is to be understood, in the meaning of the present invention, a succession of identical or similar elements connected to one another by mechanical linkages.

By “continuous support”, it is to be understood that all the accessories 34 firmly secured to the support 12, and the breakable linkages 36 connecting the accessories 34 to one another, are conjointly displaceable in at least two directions along the length of the support 12.

In the example shown in FIG. 2, the button 38, the accessories 34, and the breakable linkages 36 are integral and produced in one piece by injection moulding of a plastics or metallic material such as polypropylene (PP), polyethylene (PE), polyamide (PA), polyester, polyethylene terephthalate (PET), polyvinyl chloride (PVC), polymethyl methacrylate (POMM), or ZAMAK.

As a variant, accessories 34 and the breakable linkages 36 are produced in one piece by bi-injection of a rigid material intended to form the breakable linkages 36 and of a flexible material intended to form accessories 34.

The cost of the continuous support 12 is therefore very low.

The accessories 34 of the chain 32, in this example, are cosmetic product applicators. They are all identical and are disposed end to end along the axis A-A′, being connected to one another by breakable linkages 36.

Thus, each accessory 34 is connected at each longitudinal end at the most to one adjacent accessory 34 by a breakable linkage 36.

The chain 32 of accessories 34 of the support 12 comprises N accessories disposed end to end, connected to one another by N−1 breakable linkages. The number of accessories N is initially greater than 2 and is advantageously between 2 and 12.

As illustrated in FIGS. 2 and 3, each accessory 34 comprises a base 40 extending substantially longitudinally and at least one transverse element 42 for cosmetic product application which protrudes transversely with respect to the base 40.

In the example shown in FIG. 2, the base 40 has a substantially trapezoidal longitudinal section passing through the axis A-A′ and a triangular cross-section, substantially matched to the cross-section of the guide path 30.

The base 40 thus extends longitudinally between a front wall 44 and a rear wall 46. It has a substantially flat upper wall 48 and two V-shaped lateral walls 50 connecting the walls 44, 46.

The front wall 44 has a longitudinal section, viewed in a vertical plane passing through the axis A-A′, inclined with respect to a plane perpendicular to the axis A-A′. It thus defines a front protection edge 52 which protrudes towards the front, towards an adjacent accessory 34. The front edge 52 extends longitudinally opposite the breakable linkage 36.

The upper wall 48 extends substantially in a horizontal plane. It blocks the lateral walls 50 towards the top and the front wall 44 and rear wall 46.

The lateral walls 50 are disposed so as to bear against the peripheral wall 22 of the distributor 14 when the accessory 34 is disposed in the body 18, and to bear against the support head 20 when the accessory 34 is disposed in the head 20.

In the example shown in FIGS. 1 to 5, the transverse application elements 42 are formed by separating/combing teeth 54 which protrude upwards away from the upper wall 48.

In the example shown in FIG. 2, the transverse elements 42 comprise three rows of longitudinal teeth 54 of increasing, then constant height, going axially from the front towards the rear of the accessory 34. Each row forms a comb for cosmetic product application.

In this example, the base 40 and the application elements 42 define an application end-piece for cosmetic product intended to come into contact with the cosmetic product and the keratin fibres of the user. The application end-piece extends longitudinally parallel to the axis A-A′.

As illustrated in FIG. 3, each breakable linkage 36 comprises a connecting rod 60 extending longitudinally along the axis A-A′ between two adjacent accessories 34.

The rod 60 is breakably fixed at its rear end in a breakable point of connection 62 on the front wall 44 of a first accessory 34. The rod 60 is rigidly fixed at its front end by a point of connection 64 on the rear wall 46 of a second accessory 34 opposite.

The rod 60 has a cross-section smaller than the cross-section of the base 40 of the accessory 34, for example at least two times smaller than this section. The cross-section of the rod 60 at the breakable point of connection 62 is moreover smaller than the average section of the rod 60.

The front edge 52 of the wall 44 protrudes longitudinally in front of the point of connection 62, thereby limiting the risk of injury to the user during the use of the accessory after the breakable linkage 36 has been broken at the breakable point of connection 62.

As will be seen hereinafter with regard to FIG. 4, each accessory 34A is detachable from the continuous support 12 by breakage of at least one breakable linkage 36 at the point of connection 62. After the breakage of the breakable linkage 36, the accessory 34A remains firmly secured to a rod 60 at the point of connection 64.

According to the invention, and as illustrated in FIG. 4, since the accessories 34A, 34B are mounted end to end while being connected by the breakable linkages 36, the length L1 of the continuous support 12, and the corresponding length of the chain 32, viewed longitudinally along the guide path 30, after breakage of the breakable linkage 36 and detachment of an accessory 34A, are respectively less than the length L0 of the continuous support 12 and than the corresponding length of the chain 32, viewed longitudinally along the guide path 30, before the breakage of the breakable linkage 36, when the accessory 34A is firmly secured to the continuous support 12.

The control button 38 is separate from the accessories 34 and the breakable linkages 36. It is fixed longitudinally at the rear of the accessory 34 located at the rear end of the chain 32.

When the continuous accessory support 12 is disposed in the guide path 30 of the distributor 14, the button 38 protrudes partially out of the distributor through the slot 28, externally with respect to the peripheral wall 22, in order to be accessible to a user's finger.

The control button 38, each accessory 34, and each breakable linkage 36 are displaceable conjointly with respect to the distributor 14 along the guide path 30 between a fully retracted position shown at the top of FIG. 5 and a plurality of deployed positions shown from top to bottom in FIG. 5.

The operation of the first device 10 according to the invention will now be described.

Initially, the device 10 is provided with a distributor 14 and at least one continuous accessory support 12 containing a plurality of cosmetic accessories 34, connected end to end by breakable linkages 36.

The continuous accessory support 12 is placed in the guide path 30, in a fully retracted position, with all the accessories 34 located in the orifice 24, being inaccessible to the user. It has a maximum initial length LO, substantially equal to the length of the body 18, as illustrated at the top of FIG. 5.

The control button 38 is then located in abutment against the rear end of the slot 28. The support head 20 contains no accessory 34.

When the user wishes to use a cosmetic accessory 34, he/she grasps the body 18 with the hand and displaces the control button 38 towards the front and the support head 20.

During this displacement, the continuous accessory support 12 passes from its fully retracted position in the orifice 24 to a first deployed position, in which the first accessory 34 located at the front end of the chain 32 is disposed in the guide path 30, bearing on the head 20.

The user can then dip the accessory 34 into the reservoir 16 of cosmetic product, then apply cosmetic product to keratin fibres such as, for example, the eyelashes. As a variant, the user deposits a dose of cosmetic product on the accessory 34.

When the user has finished applying the cosmetic product, he/she moves the control button 38 again in the slot 28 towards the support head 20. As illustrated by step (b) of FIG. 4, the first accessory 34A located at the front end of the continuous support 12 then protrudes towards the front, beyond the support head 20. A second accessory 34B adjacent to the accessory 34A and located at the rear of the latter is then disposed in the guide path 30, bearing on the support head 20.

The first accessory 34A, and also the rod 60 connecting the first accessory 34A to the second accessory 34B then protrude beyond the head 20.

The user then grasps the rod 60 with the fingers and pivots it downwards or/and twists it around its axis to break the breakable linkage 36 at the point of connection 62.

As illustrated by step (d) in FIG. 4, the first accessory 34A is then detached from the rest of the chain 32. As already seen above, the length of the chain 32, and therefore the length L1 of the continuous accessory support 12, after detachment of the first accessory 34A, are then respectively less than the length of the chain 32 and the length L0 of the continuous support 12 before the breakage of the breakable linkage 36 between the first accessory 34A and the second accessory 34B.

The user can then use the second accessory 34B for the application of the same cosmetic product or of another cosmetic product.

As illustrated in FIG. 5, the preceding operations are repeated in order to use the N accessories of the support in succession while gradually reducing the length L0 to L4 of the continuous support and of the chain 32 each time an accessory 34 is detached.

Since the continuous accessory support 12 can be produced in one piece with the accessories 34, the breakable linkages 36 and the control button 38 which are integral, its cost decreases substantially. Moreover, since the distributor 14 comprises a grip body 18 which can be used with several accessories 34 in succession, even with several continuous accessory supports 12, the device 10 is compact and simple to use.

FIG. 6 illustrates the continuous accessory support 12 of a second device according to the invention.

Differing from the first device 10, the continuous support 12 comprises, for each accessory 34, a longitudinal base 40 devoid of cosmetic product application means, and a connecting arm 70 which protrudes transversely with respect to the base 40.

The cosmetic product application element 42 intended to come into contact with the keratin fibres of the user is disposed at the free end of the arm 70, away from the base 40. The base 40 is not intended to come into contact with the keratin fibres of the user.

The arm 70 extends along an inclined axis B-B′ which forms with the axis A-A′ a non-zero angle of between, for example, 90° and 160°.

Furthermore, the breakable linkages 36 are formed by thinned strips 72 having a cross-section, viewed in a plane substantially perpendicular to the axis A-A′, which is less than the cross-section of the base 40.

The operation of the second device according to the invention is otherwise similar to that of the first device 10.

A third device 90 according to the invention is shown schematically in FIG. 7. Differing from the first device 10, the distributor 14 of the third device 90 has a circular section, viewed in a horizontal plane, and a cylindrical shape with axis C-C′ perpendicular to the guide path 30.

The guide path 30 extends in a conduit of circular or helical shape with axis C-C′. The conduit is located at the periphery of the distributor 14.

The support head 20 protrudes radially away from the axis B-B′.

In the third device 90, the continuous accessory support 12 has a circular or helical shape when it is disposed in the distributor 14.

The operation of the third device 90 according to the invention is otherwise similar to that of the first device 10.

In another alternative form of device according to the invention, the distributor 14 is devoid of a support head 20, each accessory 34 being kept protruding outside the distributor 14 by the breakable linkage 36 during the application of the cosmetic product.

FIG. 8 illustrates alternative forms of cosmetic accessories 34 intended to form a chain 32 for devices according to the invention.

The accessories 34 form or comprise, for example, cosmetic product applicators, provided with a foam, a felt, a sinter, a woven fabric, a non-woven fabric, or a sponge 100 (variant (a) in FIG. 8), a brush 102 (variant (b) in FIG. 8), a brush with twisted or injection-moulded core, or a comb 104 (variant (c) in FIG. 8), a porous thermoplastic 106 (variant (d) in FIG. 8), a flocked end-piece, a synthetic foam dressing a moulded part, or a spatula.

Such accessories 34 may also form or comprise cosmetic treatment tools such as a rasp, a massage ball 108 (variant (e) in FIG. 8), a cuticle pusher 110 (variant (f) in FIG. 8) or a nail file 112 (variant (g) in FIG. 8).

A fourth device 120 according to the invention is shown in FIGS. 9 and 10.

Differing from the first support device 10, the peripheral wall 22 has along the slot 28 transverse notches 122 opposite one another, for indexing the displacement of the continuous support 12 in the orifice 24. The button 38 is provided, in its internal portion engaged in the slot 28, with a nib 124 capable of engaging laterally in the notches 122 to mark the indexing to the touch.

In addition, the orifice 24 has a cruciform cross-section.

As illustrated in FIG. 10, the button 38 comprises a guide member 126 having a cross-section complementary to that of the orifice 24 to guide the displacement of the accessory support 12 in the orifice 24 along the axis A-A′.

The chain 32 of accessories 34 comprises a plurality of accessories 34 connected to one another by breakable linkages 36, each accessory 34 having application elements 42 disposed in the shape of a cross about the central base 40 with axis A-A′.

Thus, each accessory 34 comprises two longitudinal rows 128A, 128B of application elements 42 forming a comb. The rows 128A, 128B protrude transversely in a first median axial plane, in opposite directions starting from the base 40.

Each accessory 34 further comprises two longitudinal perpendicular rows 128C, 128D of application elements 42 forming a comb. The perpendicular rows 128C, 128D extend in a second median axial plane perpendicular to the first axial plane, protruding from the base 40, opposite one another.

Thus, the accessories 34 are received in a substantially complementary manner in the slot 24 in the shape of a cross, with each row 128A, 128B, 128C, 128D received in a separate lateral extension of the cross.

A fifth device 140 according to the invention is shown in FIGS. 11 and 12. Differing from the first device 10, the peripheral wall 22 is of substantially oval shape, generally elongate in a median plane passing through the slot 28, the plane being vertical in FIG. 11.

Differing from the first device 10, the base 40 of each accessory 34 of the chain 32 comprises an axial framework 142 and a cup 144 for receiving an application element 42. The element 42 is shown schematically by semi-solid lines in FIG. 11 and FIG. 12.

The framework 142 is solid and extends between the front wall 44 and the rear wall 46.

The cup 144 protrudes transversely with respect to the framework 142. It defines an inner seating 146 for receiving the application element 42.

In this example, the cup 144 is substantially cylindrical in shape and extends along an axis inclined with respect to the axis A-A′ by an angle of more than 100 and substantially equal to 45° in the example in FIG. 12.

The seating 146 is blocked towards the axis A-A′ by the framework 42 and opens out away from the axis A-A′ through an opening 148 for insertion of the application element 42. The application element 42 is thus mounted in the cup 144, presenting an applicator which protrudes away from the opening 148. The applicator is for example a flocked end-piece, a sponge, a brush or any one of the applicators described in FIG. 8 or in the foregoing.

FIGS. 13 and 14 illustrate a sixth device 150 according to the invention.

Differing from the second device according to the invention, shown in FIG. 6, the application element 42 comprises at its free end a dry product head loaded on the applicator.

The dry product is intended to be mixed with a fluid product before the application of the mixture on the user.

During the use of the sixth device 150, the application element 42 comprising the dry product is dipped in the fluid product before the application of the mixture to a body surface of a user.

In addition, the arms 70 are substantially perpendicular to the axis A-A′ in the example shown in FIGS. 13 and 14.

A seventh device 160 according to the invention is shown in FIGS. 15 and 16. Differing from the first device 10, the base 40 of each accessory 34 defines a receptacle 162 capable of receiving a block of cosmetic product. The receptacle comprises two lateral cheeks 164 and a bottom provided with transverse ridges 166 for attaching the block of cosmetic product intended to be loaded into the receptacle 162.

As illustrated in FIG. 17, each receptacle 162 is loaded, during the manufacture of the seventh device 160, or prior to use, with a block 168 of cosmetic product which is fixed in the receptacle 162 between the cheeks 164. Fixing is effected for example by snap-fitting into the ridges 166.

The operation of the seventh device 160 is otherwise similar to that of the first device 10.

1. A cosmetic accessories distribution device comprising:
at least one accessory support comprising a plurality of cosmetic accessories, each cosmetic accessory being detachable with respect to the other cosmetic accessories of the accessory support;
a cosmetic accessory distributor defining a guide path for the accessory support, the accessory support being displaceable along its length in the guide path between a position retracted into the distributor and a plurality of deployed positions for use of an accessory;
wherein the accessory support comprises at least one chain of cosmetic accessories disposed end to end, being connected to one another by breakable linkages, the breakage of one of the breakable linkages in order to detach a cosmetic accessory from the support resulting in a reduction in the length of the chain of accessories, viewed along the guide path.

2. A device according to claim 1, wherein the plurality of cosmetic accessories and the breakable linkages of the chain of accessories are integral.

3. A device according to claim 1, wherein each cosmetic accessory comprises:
a longitudinal base connected to a longitudinal base of at least one adjacent accessory by a breakable linkage; and
at least one transverse portion which protrudes transversely with respect to the longitudinal base.

4. A device according to claim 3, wherein the base and the transverse portion form an applicator end-piece for cosmetic product.

5. A device according to claim 3, wherein the transverse portion comprises a connecting arm which protrudes transversely with respect to the longitudinal base, and an applicator end-piece for cosmetic product disposed at a free end of the arm.

6. A device according to claim 1, wherein each breakable linkage comprises a longitudinal member having a first point of connection with a first accessory of the chain of accessories and a second point of connection with a second accessory of the chain of accessories.

7. A device according to claim 6, wherein at least the first accessory has an edge for protection of the user which protrudes longitudinally with respect to the first point of connection towards the second accessory, the protection edge extending longitudinally in register with the longitudinal member.

8. A device according to claim 1, wherein the guide path defined by the distributor is linear, the accessory support extending linearly at least when said accessory support is disposed in the guide path of the distributor.

9. A device according to claim 1, wherein the guide path defined by the distributor is curved, the accessory support assuming a curved configuration at least when the accessory support is disposed in the guide path of the distributor.

10. A device according to claim 1, wherein the accessory support comprises a member for displacement of the chain of accessories in the distributor, mounted to be secured and separate from the chain of accessories, the displacement member being capable of being grasped by a user of the device via the distributor in order to displace the chain of accessories in the distributor along the guide path.

11. A device according to claim 1, wherein the distributor comprises:
a hollow body for receiving the accessory support; and
a support head protruding from the hollow body, the guide path extending through the hollow body and through the support head, each accessory being covered by the hollow body to prevent the use of the accessory when the accessory is disposed in the hollow body, the space located above an accessory being freed to permit the use of the accessory when the accessory is disposed in the support head.

12. A device according to claim 1, wherein the guide path of the distributor is defined by a groove or a channel having a cross-section substantially matched to the cross-section of at least one cosmetic accessory of the accessory support.

13. A device according to claim 1, wherein each cosmetic accessory is selected from a cosmetic product applicator or a cosmetic treatment tool.

14. A method of preparation of a device according to claim 1 for using a cosmetic accessory, said method comprising the following steps:
displacing the accessory support in the guide path as far as a deployed position;
breaking a breakable linkage between a first cosmetic accessory and a second cosmetic accessory, the breaking of the breakable linkage and a detaching of the first cosmetic accessory resulting in a reduction in the length of the chain of accessories, viewed along the guide path.
